(19) United States
(12) Patent Application Publication
(10) Pub. No.: US 2026/0167334 A1
(43) Pub. Date: Jun. 18, 2026

(54) REMOVABLE CLOSURE DEVICE FOR CLOSING OFF A SPACE, IN PARTICULAR FOR AN AIRCRAFT CABIN

(71) Applicants: Safran Seats, Plaisir (FR); iD-product, Toulouse (FR)

(72) Inventors: Bastien Bonnefoy, Moissy-Cramayel (FR); Benjamin Cans, Toulouse (FR)

(21) Appl. No.: 18/710,585

(22) PCT Filed: Nov. 15, 2022
(86) PCT No.: PCT/EP2022/082032

§ 371 Date: May 15, 2024

(30) Foreign Application Priority Data
Nov. 17, 2021 (FR) FR2112124

(51) Int. Cl. B64D 11/06; B64D 11/00

(52) U.S. Cl. CPC B64D 11/0606; B64D 11/003; B64D 11/0605; B64D 11/0641; B64D 2011/0053

(57) ABSTRACT

The present invention relates to a removable closure device for closing off a space, in particular for an aircraft cabin, comprising:
a frame comprising a housing, and
a movable door able to move translationally with respect to the frame,
the removable closure device further comprising a return system comprising a cable reel around which a cable is wound, the cable being connected by one of its ends to the movable door, and
a spring system configured to store mechanical energy when the cable is in an unwound state subsequent to a movement of the door towards the deployed position, and to release this mechanical energy so as to automatically return the movable door from the deployed position to the stored position subsequent to the movable door being released.

The present invention relates to a removable closing device for a space, in particular for an aircraft cabin. The invention finds a particularly advantageous application with aircraft cabins equipped with seat units of “business class” and “first class” type.

In a manner known per se, such a seat unit comprises a seat associated with a side console and a privacy shell extending at least partly around the seat.

Such a seat offers the passenger different comfort positions, from a “seated” position to a “bed” position, in which the seat defines a substantially horizontal sleeping surface so that the passenger can lie down. Intermediate comfort positions are also offered, such as a “relax” position in which the seat back is strongly inclined. Usually, these intermediate positions are obtained by inclining the pivoting seat back about a horizontal axis perpendicular to an axis of extension of the seat. The passenger can remain on the seat during transitions between different positions. Usually, such a seat comprises in particular a seat back and a seating surface and is likely to include a leg rest and/or a foot rest, which may be fixed or linked to a kinematics of the seat.

Certain seat arrangements for aircraft cabins of “Business Class” type allow direct access to an aisle for all passengers, via a passage between two seats one behind the other along a longitudinal axis of the aircraft cabin.

In order to guarantee the privacy of the passenger, it is possible to provide a removable partition wall which can selectively close or clear the access passage to an aisle. For example, document FR3078946 describes a separation device comprising a reel around which a flexible curtain is wound into the stored position. When the flexible curtain is unrolled, it is possible to create with the privacy shell an enclosed or semi-enclosed space around the seat unit. However, the reel has a significant mass and bulk. The integration of the reel into the seat unit therefore has the effect of reducing the passenger's living space.

The objective of the invention is in particular to effectively remedy this drawback by proposing a removable closing device for a space in particular for an aircraft cabin, which device comprises:
a frame including a housing, and
a movable door capable of moving in translation relative to the frame between a stored position in which the movable door is mainly inside the housing and a deployed position in which the movable door is mainly outside the housing,
said removable closing device further comprising a return system including a cable reel around which a cable is wound, said cable being connected by one of its ends to the movable door, and
a spring system configured to store mechanical energy when the cable is in an unwound state due to a movement of the door towards the deployed position, and
to release this mechanical energy so as to automatically return the movable door from the deployed position to the stored position due to a release of the movable door.

The invention thus permits, thanks to the cable system, to obtain a gain of mass, cost, and bulk increasing the passenger's living space. The invention also has a security character insofar as the return system allows the door to automatically return by default to the stored position in the event of an emergency evacuation.

According to one embodiment of the invention, the cable reel is linked in rotation to a pinion meshing with a reduction pinion.

According to one embodiment of the invention, the reduction pinion is coupled with a damper pinion so as to control a return speed of the movable door to the stored position.

According to one embodiment of the invention, the movable door comprises a toothed wheel meshing with a rack fixed on the frame.

According to one embodiment of the invention, the spring system comprises a spring reel around which a blade spring is wound at least in part, said blade spring also being connected to the cable reel.

According to one embodiment of the invention, said removable closing device comprises a device for locking and unlocking the movable door in the stored position.

According to one embodiment of the invention, the locking and unlocking device comprises a handle for cooperating with a counter-form in the frame.

According to one embodiment of the invention, the locking and unlocking device comprises a rotary latch provided with a projecting portion, said projecting portion being provided so as to be inserted inside a corresponding housing in the handle when the device is in a locked state.

According to one embodiment of the invention, the handle comprises a button capable of tilting the latch so as to disengage the projecting portion relative to the housing and place the device into an unlocked state.

According to one embodiment of the invention, said removable closing device includes a device for holding the door in the deployed position.

According to one embodiment of the invention, the door holding device is a magnetic device.

According to one embodiment of the invention, magnets on a structural upright of the door and/or on the handle are provided so as to cooperate with integrated magnetic elements on a front seat unit.

According to one embodiment of the invention, said removable closing device comprises at least one slide connection between the door and the frame.

According to one embodiment of the invention, the frame comprises a cavity in a panel so as to increase a living space at the shoulders of a passenger.

According to one embodiment of the invention, the movable door comprises a panel made of a flexible material and two finishing panels on either side of the flexible panel.

The invention also relates to a seat unit in particular for an aircraft cabin comprising a removable closing device as previously defined.

The invention further relates to an aircraft cabin comprising an aisle, at least one seat unit provided with a removable closing device as defined above and capable of selectively closing or clearing an access passage to the aisle.

The present invention will be better understood and other characteristics and advantages will become apparent on reading the following detailed description comprising embodiments given by way of illustration with reference to the appended figures, presented by way of non-limiting examples, which may be used to complete the understanding of the present invention and the presentation of its realization and, if necessary, contribute to its definition, wherein:

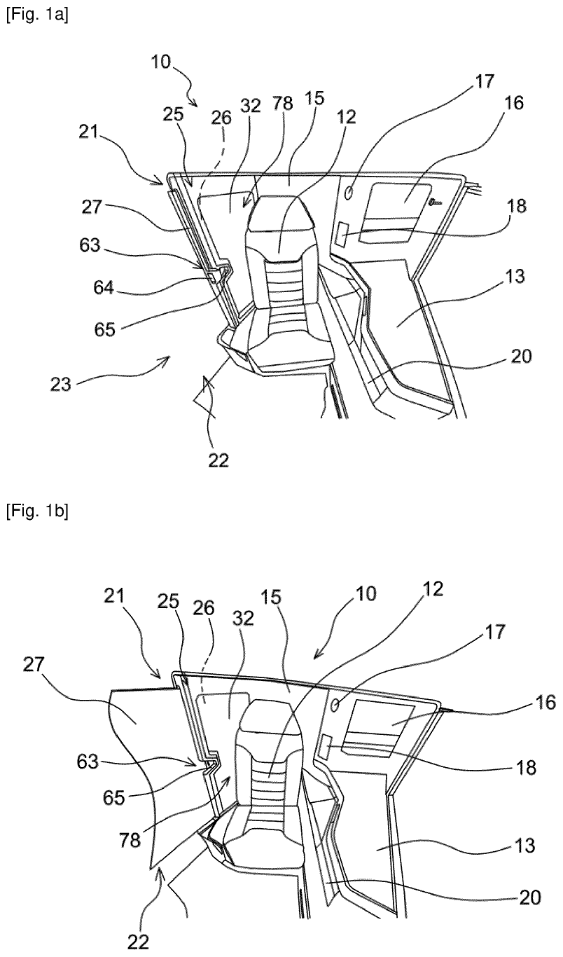

FIGS. 1a and 1b are perspective views of a seat unit provided with a removable closing device for a space according to the invention respectively in the stored position and in the deployed position;

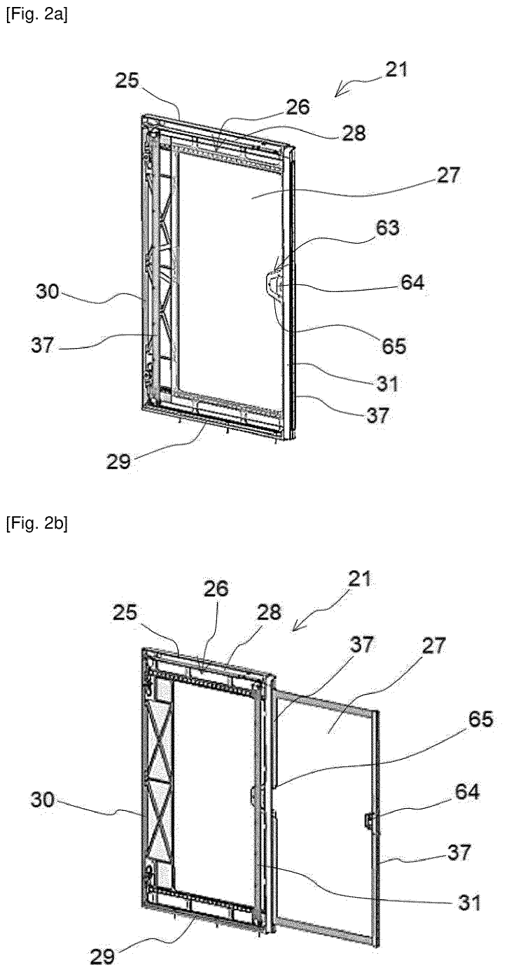

FIGS. 2a and 2b Are perspective views of a removable closing device for a space according to the invention respectively in the stored position and in the deployed position;

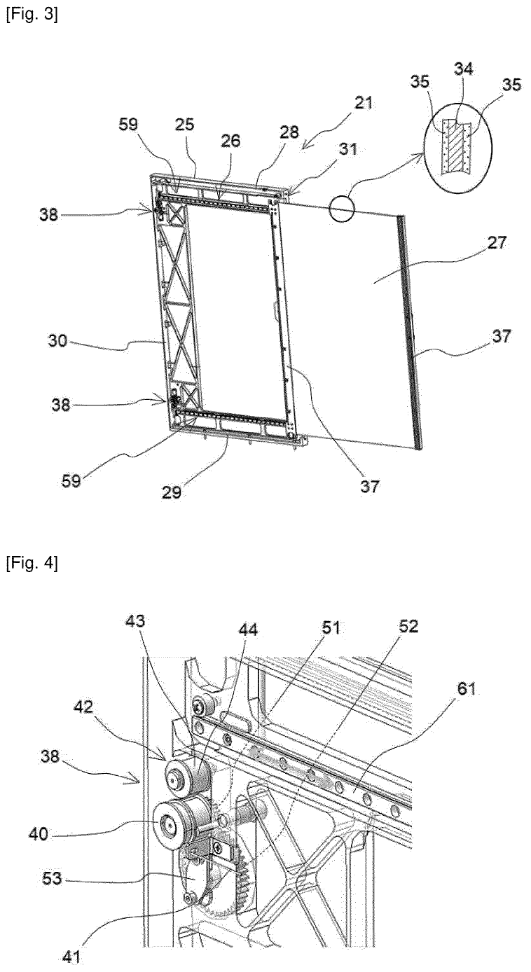

FIG. 3 is a view of the closing device according to the invention showing the installation of door return devices at the upper and lower ends of a frame;

FIG. 4 is a detailed perspective view of a portion of the frame comprising a system for returning the door to the stored position;

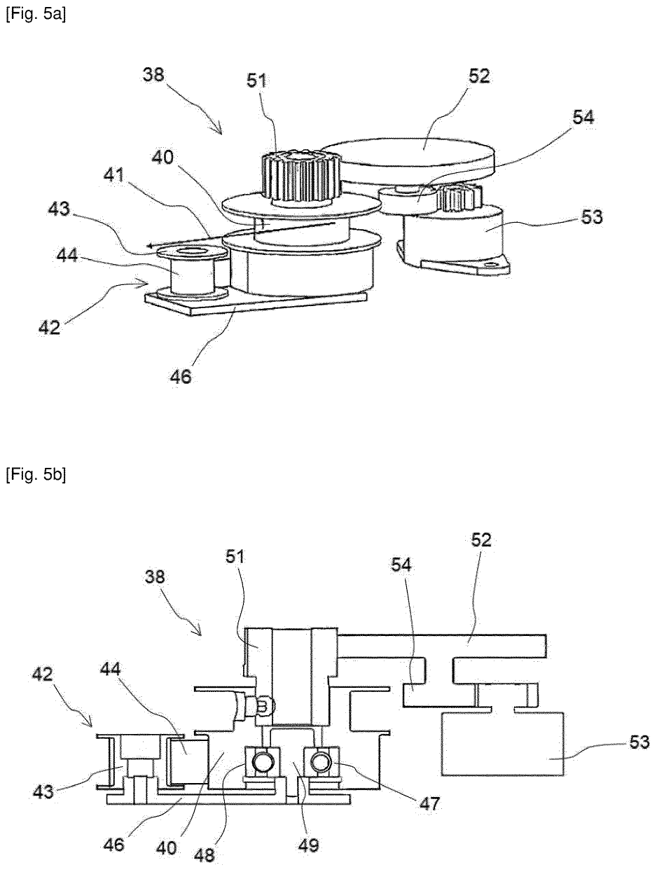

FIGS. 5a and 5b are respectively perspective and sectional views of a system for returning a movable door according to the invention;

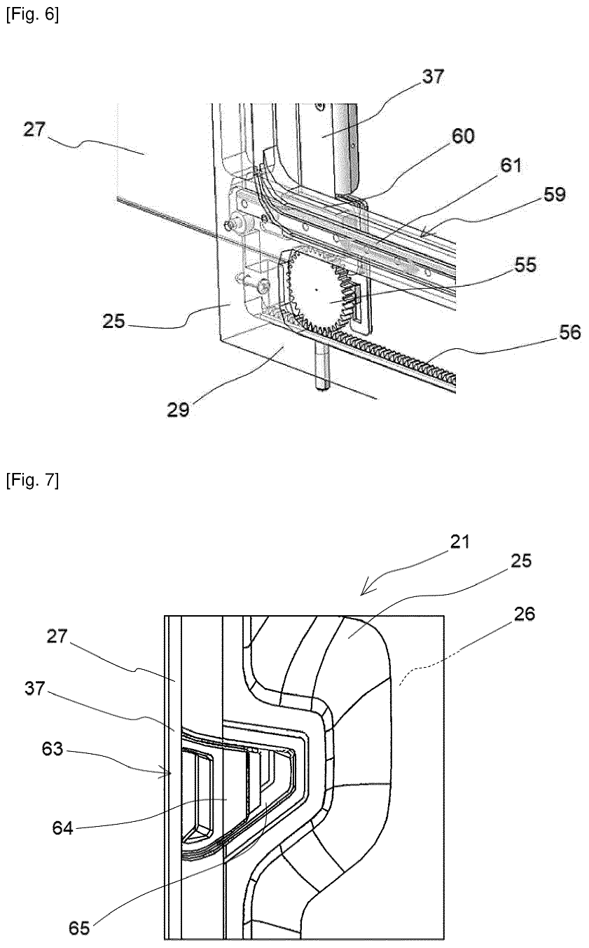

FIG. 6 is a detailed perspective view of the rack device making it possible to control a speed of the movable door according to the invention;

FIG. 7 is a detailed perspective view of a handle incorporating a device for locking and unlocking the movable door in the stored position;

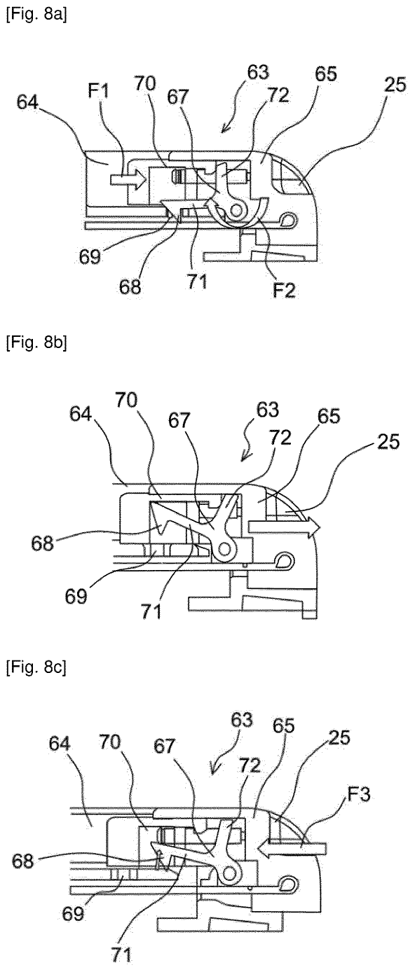

FIGS. 8a to 8c illustrate the steps of unlocking the handle of the closing device for a space according to the invention;

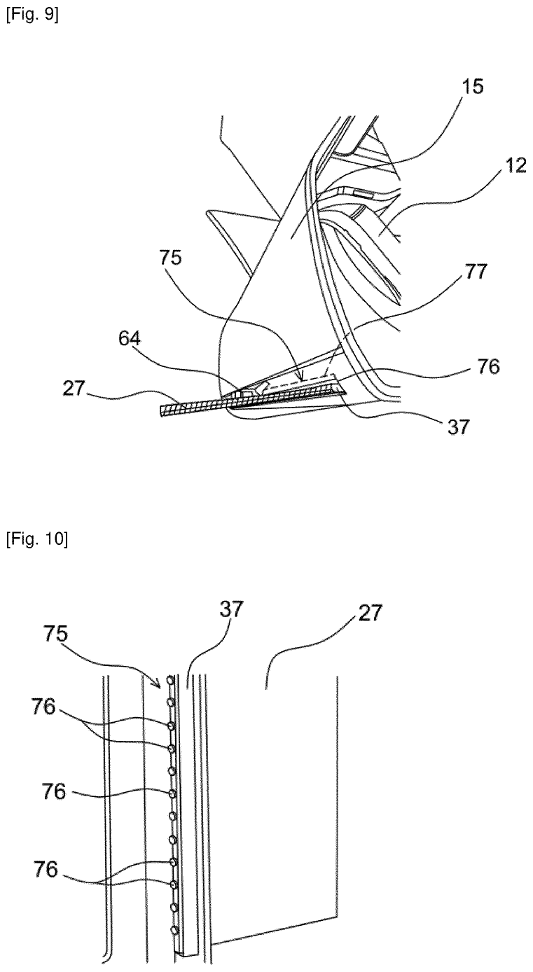

FIG. 9 is a detailed perspective view of a magnetic contact zone between a structural strut the door and a portion of a cabinet of a front seat unit making it possible to maintain the movable door in the deployed position by magnetic attraction;

FIG. 10 is a detailed perspective view of an structural strut of the door of a closing device according to the invention comprising a plurality of magnets so as to ensure the magnetic retention of the door in the deployed position;

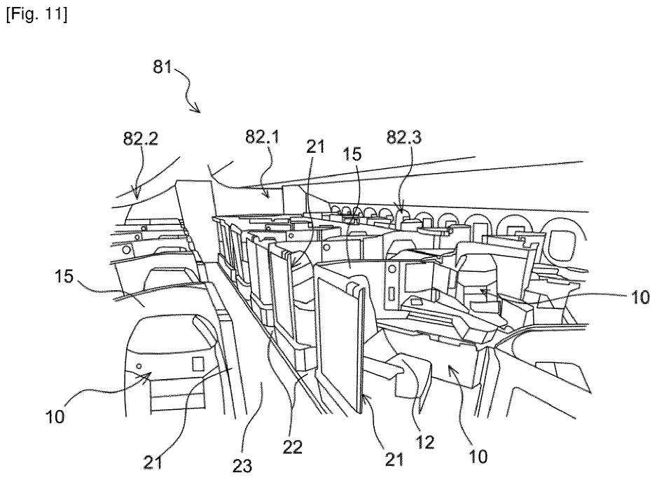

FIG. 11 is a perspective view of an aircraft cabin comprising a plurality of seat units each comprising a removable closing device for an access passage to an aisle.

It should be noted that the structural and/or functional elements common to the different embodiments may have the same references. So, unless otherwise stated, such elements have identical structural, dimensional and material properties.

Furthermore, in the remainder of the description, the relative terms of the type “horizontal” or “vertical” are understood by reference to the common sense that a passenger on a seat which a removable closing device for a space according to the invention is associated with would give them.

FIGS. 1a and 1b show a seat unit 10 comprising at least one seat 12 associated with a side console 13 extending along one side of the seat 12. A shell 15 extends at least partly around the seat 12 so as to delimit a semi-enclosed space around the passenger. Such a configuration permits to guarantee the privacy of the passenger on the seat 12. A video screen of a multimedia system or IFE (Inflight Entertainment System) could be installed on a rear part of the privacy shell 15.

At the rear end of the console 13, a storage space 16 can be provided comprising one or more elements such as a literature pouch, a bottle holder, or a minibar. The choice of the elements to be stored can be configured according to the wishes of the airline.

The console 13 may also include a reading light 17 as well as a control unit 18 for the seat and the environment thereof (called “PCU” for “Passenger Control Unit”). The control unit 18 allows in particular the passenger to control the selection of a position of the seat as well as elements of the environment of the seat 12, such as a video system, a heating device, a device for creating a lighting atmosphere, or any other element of the seat environment.

The seat unit 10 may also usually include a meal flap 20 movable between a stored position (corresponding to that in FIGS. 1a and 1b) in which the meal flap 20 is inside a housing in the console 13 and a deployed position in which the meal flap 20 is outside the housing.

The seat 12 is advantageously provided with kinematics allowing it to be movable between a “seating” position in which the seat 12 is configured to define a seating position for a passenger, and a “bed” position in which the seat 12 is configured to define a sleeping surface for the passenger, advantageously substantially horizontal. Intermediate comfort positions are also offered, such as the “relax” position in which a back of the seat 12 is strongly inclined. Generally, these intermediate positions are obtained by inclining the pivoting seat back about a horizontal axis and perpendicularly to an axis of extension of the seat. The passenger can remain on the seat during transitions between different positions.

A removable closing device 21 permits to selectively close an access passage 22 to an aisle 23 of an aircraft so as to give privacy to the passenger or clear this access passage 22 in the case the passenger wishes to get out of the seat 12. The access passage 22 extends between the seat unit 10 and a privacy shell 15 of a front seat unit 10.

More precisely, as can be seen in FIGS. 2a, 2b, and 3, the removable closing device 21 comprises a frame 25 including a housing 26. A movable door 27 is able to move in translation relative to the frame 25 between a stored position in which the door 27 is mainly inside the housing 26 (see FIGS. 1a and 2a) and an deployed position in which the door 27 is mainly outside the housing 26 (see FIGS. 1b and 2b). In this case, the movement of the door 27 is carried out in a horizontal direction. Alternatively, the movement of the door 27 is carried out in a vertical direction.

As can be seen in particular in FIG. 3, the frame 25 comprises a structure formed by an upper edge 28, a lower edge 29, and two side edges 30, 31 mechanically connecting the upper edge 28 and the edge lower 29 to one another. The structure of the frame 25 can be covered with finishing panels 32 visible in FIGS. 1a and 1b.

As can be seen in FIG. 3, the movable door 27 comprises a panel 34 made of a flexible material, such as fabric. Two finishing panels 35 can be arranged on either side of the flexible panel 34 so as to form a stacked structure of the “sandwich” type. The finishing panels 35 may be made of a plastic material. The finishing panels 35 may include designs that can be personalized by the airline.

A structural upright 37 of vertical orientation is arranged at each end of the panel 34. The structural uprights 37 are made of a rigid material, for example metal or a rigid plastic material. As explained in more detail below, the structural uprights 37 are intended to carry functional components of the door 27. Preferably, in order to limit weight, the door 27 is provided without structural element extending between the end uprights 37. Alternatively, the door 27 could, however, include a frame to which the flexible panel 34 is connected through removable means, such as self-gripping fasteners or press studs or any other device adapted to the application, so that the flexible panel 34 can be easily separated from the frame in the event of an emergency evacuation.

Furthermore, as can be seen in FIGS. 4, 5a, and 5b, a return system 38 comprises a cable reel 40 around which a cable 41 is wound. The cable 41 is connected by one of its ends to the movable door 27. In addition, a spring system 42 is configured to store mechanical energy when the cable 41 is in an unwound state due to a movement of the door 27 towards the deployed position, and to release this mechanical energy so that the door 27 can automatically return from the deployed position to the stored position due to a release of the movable door 27.

In the example shown, the spring system 42 comprises a spring reel 43 around which a spring leaf 44 is wound at least in part. The spring leaf 44 is also connected to the cable reel 40. The spring leaf 44 is for example made of an elongated metal strip wound at least partly around the spring reel 43 and connected to the cable reel 40. Thus, when the door 27 moves from the stored position to the deployed position, the mechanical energy is stored by winding the spring leaf 44 around the cable reel 40. Alternatively, the spring system 42 may be made of a torsion spring at the axis of the cable reel 40 or any other device adapted to the application.

The cable reel 40 thus includes a portion around which the cable 41 is wound and an axially adjacent portion around which a portion of the spring leaf 44 can be wound during mechanical energy storage.

The cable reel 40 and the spring reel 43 are two distinct reels having distinct axes parallel to each other. The cable reel 40 and the spring reel 43 can be mounted on a support plate 46 to be fixed to the frame 25. A bearing 47 is arranged in an internal housing 48 of the cable reel 40. The bearing 47 is mounted on a shoulder screw 49 fixed to the support plate 46.

In order to control the return speed of the door 27 to the stored position, the cable reel 40 is rotatably connected to a pinion 51 meshing with a reduction pinion 52. The reduction pinion 52 is coupled with a damping pinion 53. For this purpose, the damping pinion 53 can mesh with a toothed wheel 54 rotatably connected to the reduction pinion 52.

As shown in FIG. 6, the door 27 may also include a toothed wheel 55 meshing with a rack 56 fixed to the frame 25. The toothed wheel 55 may be mounted so as to rotatably move relative to a structural upright 37 of the movable door 27.

In order to optimize the guiding of the door 27 relative to the frame 25, it is possible to provide a slide connection 59 between the door 27 and the frame 25. The slide connection 59 is formed by at least one pad 60 fixed to the door 27, in particular to a structural upright 37 of the door 27, cooperating with a rail 61 fixed to the frame 25. Alternatively, the structure could of course be inverted, that is to say the rail 61 can be fixed to the door 27 while the pad(s) 60 can be fixed to the frame 25.

According to a particular embodiment shown in FIG. 3, the removable closing device 21 comprises two return systems 38 and two slide connections 59 in the upper and lower part of the frame 25. Alternatively, it is possible to provide a single return system 38 and/or a single slide connection 59.

Advantageously, as shown in FIGS. 7, 8a, 8b, and 8c, a device 63 is provided for locking and unlocking the movable door 27 in the stored position. The locking and unlocking device 63 comprises a handle 64 for cooperating with a counter-form 65 in the frame 25.

For this purpose, a rotary latch 67 is provided with a projecting portion 68 to be inserted inside a corresponding housing 69 in the door 27 when the device 63 is in a locked state. The handle 64 includes a button 70 capable of tilting the latch 67 so as to disengage the projecting portion 68 from the housing 26 when the device 63 is in an unlocked state.

In the example shown, the latch 67 has a tab 71 comprising the projecting portion 68 and a stop tab 72 so as to have an L shape.

As shown in FIG. 8a, the button 70 is movable in translation so as to push the stop tab 72 along the arrow F 1. This causes the latch 67 to rotate about its axis along the arrow F2.

As shown in FIG. 8b, due to the movement of the button 70, the latch 67 is disengaged from the housing 69.

As shown in FIG. 8c, releasing the button 70 causes it to return to a rest position along the arrow F3. The door 27 is then unlocked and can be moved to its deployed position.

The axis of the latch 67 is preferably spring-mounted so that the locking of the door 27 is carried out automatically when the latter returns to the stored position.

As illustrated in FIGS. 9 and 10, the removable closing device 21 may also include a device 75 for holding the door 27 in the deployed position. The holding device 75 is preferably of magnetic type.

For this purpose, magnets 76 are arranged on a structural upright 37 of the door 27, in particular the front end upright 37, and/or the handle 64. These magnets 76 are intended to cooperate with magnetic elements 77 integrated into a corresponding wall of a seat unit 10 in front of the frame 25. The wall of the front seat unit 10, in particular a wall of the privacy shell 15, can thus integrate magnets or metal portions generating a magnetic attraction of the magnets 76 of the movable door 27.

Furthermore, as illustrated in FIGS. 1a and 1b, the frame 25 may include a cavity 78 formed in a panel 34 so as to increase the living space at the shoulders of a passenger.

One describes below, with reference to FIGS. 1a and 1b, the use of the closing device 21 according to the invention initially in the stored position.

When the passenger wants privacy, s/he can activate the button on the handle 64 in order to disengage the latch 67 from its housing 26 in order to unlock the door 27. The passenger then pulls on the handle 64 in order to slide the door 27 into the deployed position. During this movement, the spring leaf 44 of the return system 38 stores mechanical energy by winding the spring leaf 44 around the cable reel 40 and at least partially unwinding the spring leaf 44 relative to the spring reel 43. The door 27 is held in the deployed position by magnetic bonding of the front structural upright 37 to a portion of the front seat unit 10.

When the passenger wishes to clear the passage 22 so as to access the aisle 23 in the aircraft, s/he pulls the handle 64 so as to move the front structural upright 37 away from the front seat unit 10. The spring leaf 44 of the return system 38 then restores the stored mechanical energy to automatically return the door 27 to the stored position, by unwinding the spring leaf 44 from the cable reel 40 and winding the spring leaf 44 around the spring reel 43.

FIG. 11 shows an aircraft cabin 81 comprising a plurality of seating units 10 one behind the other in the form of columns 82.1, 82.2, and 82.3.

The aircraft cabin 81 may for example include a central column 82.1 and two side columns 82.2, 82.3 on either side of the central column 82.1. The central column 82.1 may consist of a plurality of sets of two adjacent seat units 10 one behind the other. A side column 82.2, 82.3 may consist of a plurality of individual seat units 10 one behind the other.

A side column 82.2, 82.3 is separated from the central column 82.1 by an aisle 23.

Each of the seat units 10 includes a removable closing device 21 capable of selectively closing or clearing their access passage 22 to the aisle 23. This access passage 22 extends between the privacy shell of a given seat unit 10 and the privacy shell of the front seat unit 10 in a given column 82.1, 82.2, 82.3.

Of course, the number of seat columns 82.1, 82.2, 82.3 may be adapted according to the configuration of the aircraft cabin 81.

Alternatively, the removable closing device 21 could be arranged between two adjacent seat units 10, for example two seat units 10 of the central column 82.1.

Of course, the different characteristics, variants and/or forms of embodiment of the present invention can be associated with each other in various combinations to the extent that they are not incompatible with one another or exclusive from one another.

Furthermore, the invention is not limited to the embodiments described above and provided solely by way of example. It encompasses various modifications, alternative forms and other variants that those skilled in the art may consider in the context of the present invention and in particular all combinations of the different modes of operation described above, which can be taken separately or in combination.

1. A removable closing device for a space for an aircraft cabin, the removable closing device comprising:
a frame comprising a housing, and
a movable door capable of moving in translation relative to the frame between a stored position in which the movable door is inside the housing and a deployed position in which the movable door is outside the housing, wherein the removable closing device further comprises a return system comprising a cable reel around which a cable is wound, said cable having ends and being connected from one of the ends to the movable door, and
a spring system configured to (i) store mechanical energy when the cable is in an unwound state due to a movement of the door towards the deployed position, and
(ii) to release the mechanical energy so as to automatically return the movable door from the deployed position to the stored position due to a release of the movable door,
wherein the spring system comprises a spring reel around which a spring leaf is wound at least in part, said spring leaf also being connected to the cable reel,
wherein said cable reel includes a portion around which the cable is wound and an axially adjacent portion around which a portion of the spring leaf can be wound during mechanical energy storage.

2. The removable closing device according to claim 1, wherein the cable reel is rotatably connected to a pinion meshing with a reduction pinion.

3. The removable closing device according to claim 2, wherein the reduction pinion is coupled with a damping pinion so as to control a return speed of the movable door to the stored position.

4. The removable closing device according to claim 1, wherein the movable door comprises a toothed wheel meshed with a rack fixed to the frame.

5. (canceled)

6. The removable closing device according to claim 1, further comprising a device for locking and unlocking the movable door in the stored position.

7. The removable closing device according to claim 6, wherein the locking and unlocking device comprises a handle for cooperating with a counter-form in the frame.

8. The removable closing device according to claim 7, wherein the locking and unlocking device comprises a rotary latch provided with a projecting portion, said projecting portion being intended to be inserted inside a corresponding housing in the handle when the device is in a locked state.

9. The removable closing device according to claim 1, further comprising a device for holding the door in the deployed position.

10. The removable closing device according to claim 1, wherein the frame comprises a panel having a cavity formed therein.

11. The removable closing device according to claim 1, wherein the movable door comprises a panel made of a flexible material and two finishing panels on either side other of the flexible panel.

12. A seat unit for an aircraft cabin, the seat unit comprising a removable closing device as defined according to claim 1.

13. An aircraft cabin comprising an aisle, at least one seat unit provided with a removable closing device as defined according to claim 1 capable of selectively closing or clearing an access passage to the aisle.
